(19) United States
(12) Patent Application Publication
(10) Pub. No.: US 2006/0081063 A1
(43) Pub. Date: Apr. 20, 2006

(54) Ligament force detection system

(76) Inventors: Timo Neubauer, Feldkirchen (DE); Norman Plassky, Erfurt (DE); Benjamin Wagner, Munich (DE)

Correspondence Address: RENNER, OTTO, BOISSELLE & SKLAR, LLP, Nineteenth Floor, 1621 Euclid Avenue, Cleveland, OH, 44115-2191, US

(21) Appl. No.: 11/247,992

(22) Filed: Oct. 11, 2005

Related U.S. Application Data
(60) Provisional application No. 60/620,812, filed on Oct. 21, 2004.

(30) Foreign Application Priority Data
Oct. 11, 2004 (EP) 04024165.5

(51) Int. Cl. G01N 3/08

(52) U.S. Cl. 73/818

(57) ABSTRACT

A ligament force detection system includes a device configured to be inserted between two body structures connected by ligaments, wherein the device exhibits a predetermined elasticity, and a medical navigation system. The medical navigation system, which is capable of detecting shifts in the body, determines forces acting on the ligaments based on shifts in the body structures and the elasticity of the device.

### RELATED APPLICATION DATA

This application claims priority of U.S. Provisional Application No. 60/620,812 filed on Oct. 21, 2004, which is incorporated herein by reference in its entirety.

### FIELD OF THE INVENTION

The invention relates to treating ligaments and, more particularly, to a ligament force detection system.

### BACKGROUND OF THE INVENTION

In the field of medicine, ligament force detection systems serve to hold body structures, such as bone structures, tensed apart, wherein forces that arise in the ligaments can be defined. The corresponding forces are to be aligned, for example, when ligament structures are manipulated, in order to restore the anatomical position of an axis, such as a leg axis. This is particularly applicable to cases in which joint prostheses are inserted.

Force and/or tension sensors are described in U.S. Pat. No. 5,470,354 and in European patent application EP 1 402 857 A2, wherein a provisional tibial component comprising an inbuilt pressure/force sensor is used to measure the ligament tension intra-operatively while a knee joint prosthesis is positioned. Such systems have the disadvantage that the sensors are arranged in an insert, e.g., in the portion between the bone structures, and typically transmit their signals, i.e., force or tension data, via a line or wires (e.g. conductive leads). Furthermore, energy supplies are required to power the electronics of such sensors. These circumstances make conventional systems complicated, difficult to handle, relatively expensive and difficult to sterilize.

### SUMMARY OF THE INVENTION

A ligament force detection system can include an insert that can be inserted between two body structures that may be connected to each other by ligaments. The detection system also can include a measurement array that determines forces acting on the ligaments.

An insert of the ligament force detection system can exhibit a predetermined elasticity (in the case of a spring, the spring constant) and reference arrays can be arranged on the body structures. Further, a measurement array can include a medical navigation system that detects shifts in the body structures via the reference arrays or structures, such that the forces acting on the ligaments can be deduced from the shifts in the body structure and the known elasticity of the detection system.

In other words, the force between the body structures (e.g., the ends of the bone) need not be continuously and directly measured to communicate a force value. Instead, the predefined elasticity of the insert can be used to define an elasticity or spring constant, and the force itself then simply can be ascertained by measuring resultant shifts or pathways. Such pathways, however, can be ascertained externally by simple measurement processes (e.g., with the aid of medical navigation systems), such that it is not necessary to communicate force values “from within” (e.g., directly from the insert) by lines or wires where they are processed or used.

The invention thus provides a way of defining the force or tension data of ligamentary structures intra-operatively, without cables and without using converters and sensors. The insert therefore can be embodied as a simple mechanical component and can be easily sterilized. Energy supplies in the insert or for the insert are no longer necessary.

Computer-assisted knee joint replacement operations have been performed in recent times and thus, the number of operating theaters equipped with navigation systems has increased. Thus, the invention can be used with existing operating theaters that employ navigation systems.

In accordance with one embodiment, the insert can include a spring having a known spring constant. The length of the spring can advantageously be adjusted by an adjusting mechanism to define a bias force of the spring in an initial position.

The insert can be constructed such that it includes an outer body in which the spring is mounted, and at least one pair of stretcher extensions, such as a pair of stretcher plates. The stretcher plates can be biased by the spring and can be inserted between the body structures. There then exists the option of constructing an insert that includes two such outer bodies, with springs and pairs of stretcher extensions, which can be arranged adjacent to one another. In the knee region, the upper and lower leg bone then can be pressed apart on both sides between the joint extensions.

In accordance with another embodiment, the two outer bodies can be connected to each other at an adjustable distance, and the two pairs of stretcher extensions can extend substantially parallel and substantially in the same direction. The latter feature, for example, can be realized by arranging the pairs of stretcher extensions such that they are jointed. If one pair of stretcher extensions is embodied to have a particular shape (e.g., longer than the other), the insert can be used in knee applications, for example, and can fulfil its function even if the patella remains in its anatomical position. This specific shape of one pair of stretcher extensions can enable the unimpeded run of the patella.

As already mentioned above, one preferred embodiment of the system is that the navigation system calculates the forces acting on the ligaments from the shifts in the body structure and the elasticity of the detection system, and outputs this information in real time.

An embodiment of the present invention is explained in the following in more detail on the basis of the enclosed drawings. The invention can comprise any of the features described therein, individually or in any combination.

### BRIEF DESCRIPTION OF THE DRAWINGS

FIG. 1 is a sectional view through an insert of an exemplary ligament force detection system in accordance with the invention, wherein said insert is also called a ligament balancing device in the following figures.

FIG. 2 is a perspective view the ligament balancing device of FIG. 1, wherein an outer portion of the device has been omitted to reveal an inner portion of the device.

FIG. 3 is a sectional view through a part of the device indicating a spring pathway.

FIG. 4 illustrates a perspective view of a system in accordance an embodiment of the invention used with an extended knee joint.

FIG. 5 is a screen shot of a navigation system that may be displayed in the system of FIG. 4.

FIG. 6 illustrates the system of FIG. 4 used with a angled knee joint.

FIG. 7 is a screen shot of a navigation system that may be displayed in the system of FIG. 6.

### DETAILED DESCRIPTION

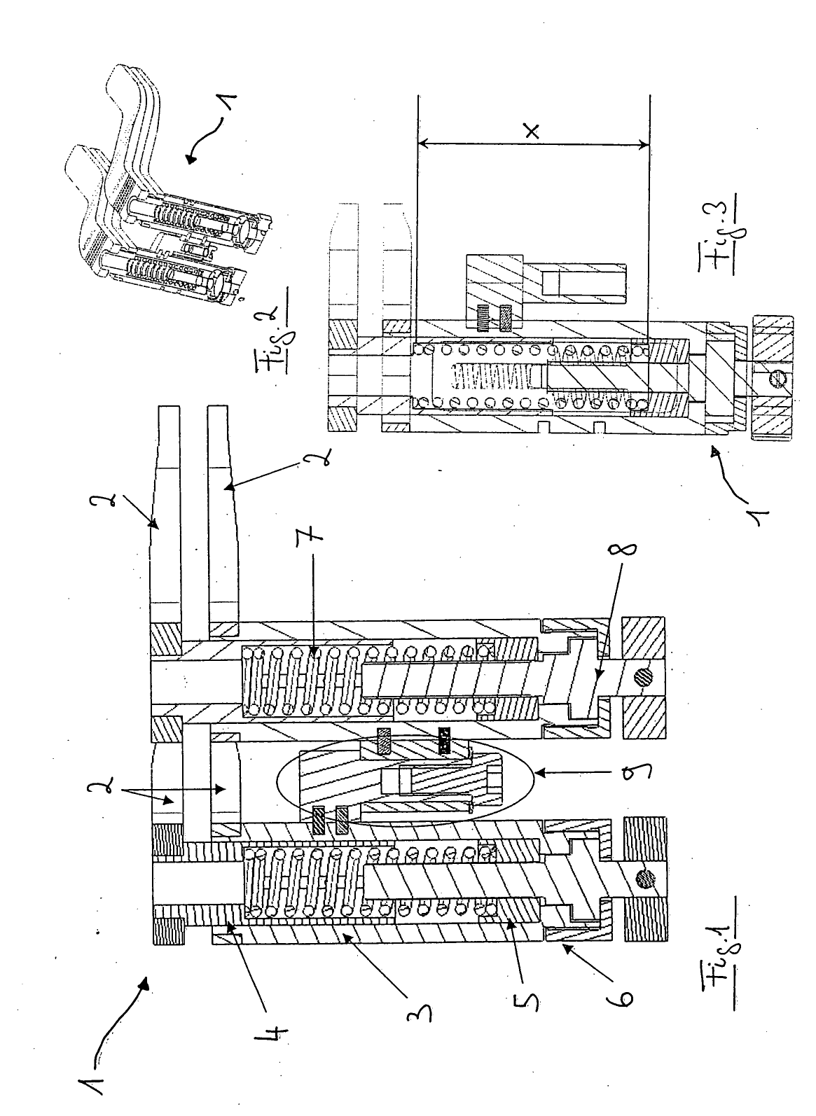

Referring to FIG. 1, there is provided a section view of an insert 1 of an exemplary ligament force detection system in accordance with the invention. As noted above, the insert also is referred to herein as a ligament balancing device 1.

The device 1 includes an outer body or outer sleeve 3 that surrounds the mechanism within. An upper inner sleeve 4 and a lower inner sleeve 5 are guided in the outer sleeve 3, and a spring 7 is inserted between the two inner sleeves 4 and 5 (numbering in the right-hand part of the device 1 is embodied in substantially the same way as the left-hand part of the device). A base part 6 is provided beneath the inner sleeve 5 and the outer sleeve 3 and is fastened to the outer sleeve 3 via a threaded fastener, for example. The base part 6 secures a thumb screw 8, which can adjust the length of the spring 7 via a helical gear (not shown). The adjustment is performed by rotating the thumb screw 8, which lifts or lowers the inner sleeve 5 upward/downward as it is guided in the outer sleeve 3. Above the upper inner sleeve 4, a pair of stretcher plates 2a and 2b are arranged on each of the left-hand and right-hand partial pieces of the device 1 (e.g., two medial stretcher plates and two lateral stretcher plates). The upper stretcher plate 2a shown in each case is fixed to the upper inner sleeve 4, and the lower stretcher plate 2b shown in each case is fixed to the outer sleeve 3. The stretcher plates 2a and 2b are pressed apart by the force of the spring 7.

A joint array 9 lies between the left-hand and right-hand part of the device 1. The joint array 9 allows said left and right hand parts to be adjusted with respect to each other, thereby allowing the distance between the stretcher plates 2a and 2b as a whole to be set. As can be seen from the perspective and sectional view in FIG. 2, one of the pairs of stretcher plates exhibits a different shape than the other. With the aid of the joint array 9, the device 1 as a whole can be set such that the two parts (i.e., the left hand and the right hand parts of the device) are near each other and the stretcher plates 2a and 2b protrude in substantially the same direction. Because one of the pairs of stretcher plates exhibits a particular shape (length, angle), it can then engage with a more distant intermediate space, and the device 1 as a whole can be positioned in knee applications, for example, such that the anatomical pathway of the knee-cap is not impeded/affected.

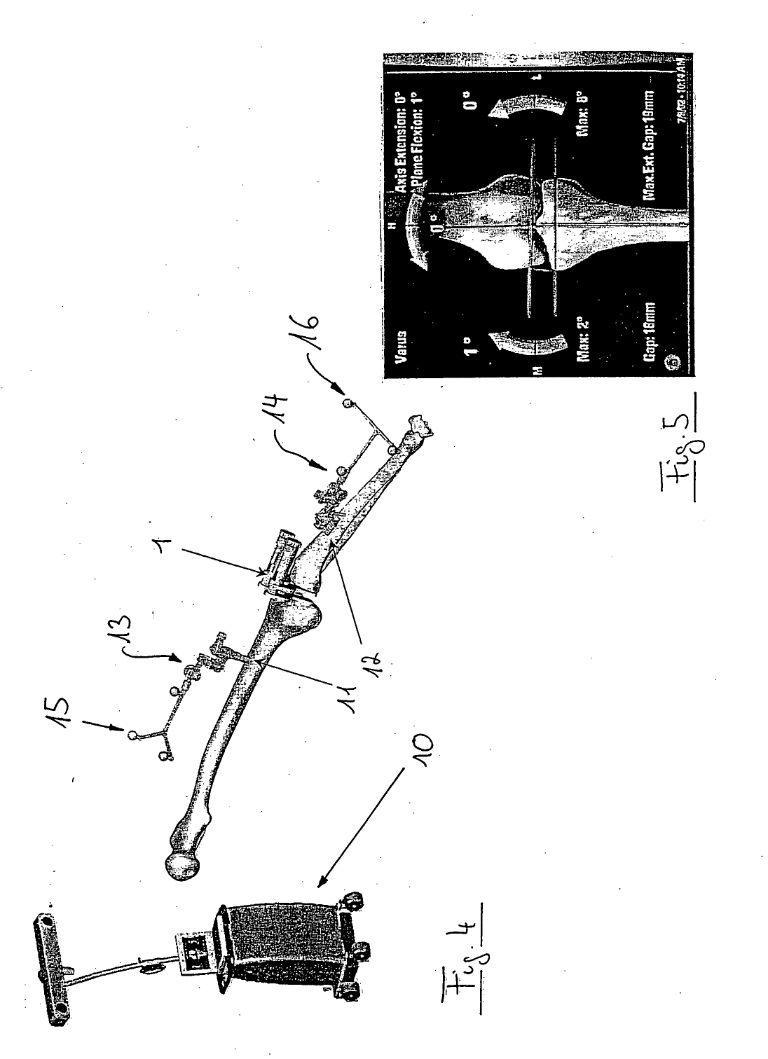

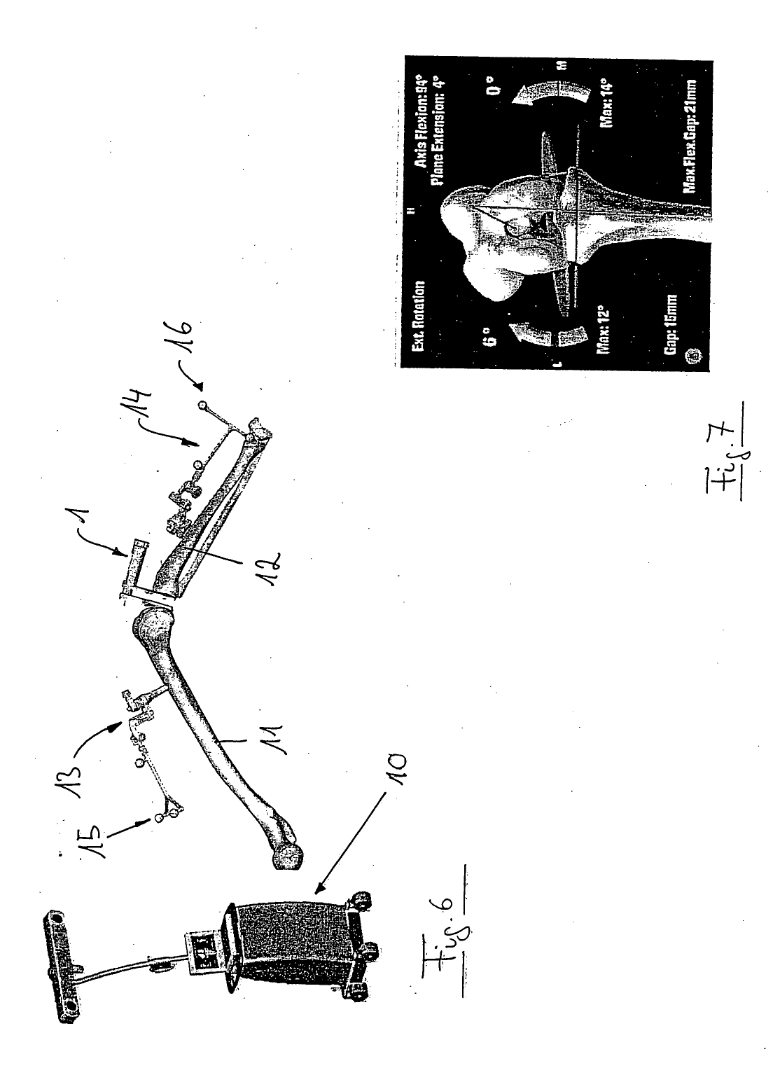

FIG. 3 only shows a part of the device 1 and denotes the spring pathway X which will be referred to again below. FIGS. 4 and 6 show ligament force detection systems in accordance with an embodiment of the invention. A difference between FIGS. 4 and 6 is that FIG. 4 shows a non-angled joint position and FIG. 6 shows an angled joint position.

On the left in FIGS. 4 and 6, a navigation system 10 is shown that includes a camera system 10a, a computer unit 10b and corresponding software. The navigation system 10 can locate positions and provide data on spatial coordinates of detected reference arrays or structures via the camera system 10a. With the aid of these data, image-guided surgery is possible. Reference structures that can be detected by the navigation system 10, for example, include reference structures 13 and 14, each of which includes marker arrays 15 and 16 arranged in a characteristic way. The reference structures 13 and 14 are fixed to bones 11 and 12, in this case the upper leg bone 11 and lower leg bone 12. The ligament balancing device 1, which includes the stretcher plates 2a and 2b described above, is inserted between the joint extensions or joint cleft 18 of the bones 11 and 12.

The functionality of the ligament force detection system will now be explained on the basis of a knee prosthesis implanting operation. With continued reference to FIGS. 4 and 6, the femur 11 and tibia 12 are provided with the reference arrays 13 and 14 and are registered in the navigation system 10 using conventional registration techniques. A proximal tibial incision is then planned based on the anterior femur pre-curvature, possibly with a slope of 5 degrees to 10 degrees. The tibial incision is then performed, and the leg is extended as shown in FIG. 4.

Next, the ligament balancing device 1 (balancing aid) is inserted into the joint cleft 18. Due to the particular shape (described above) of one of the pairs of stretcher plates, the patella can remain at its anatomical position. When the device 1 is inserted in the joint cleft 18, the medial and lateral ligament (not shown) will exert a counter force. In accordance with the value of this force, the spring 7 (FIG. 1) is compressed to a particular length. It is possible to stretch open the joint cleft 18 with the same force medially (situated in) and laterally (situated on at or on the side), such that the mechanical axes of the bones are aligned. The existing force, e.g., the force on the medial and lateral ligament, can be calculated from the difference between the unloaded spring length X (FIG. 3) and the compressed spring length, and from the spring constant. The force can be read on a scale on the device 1 itself, for example.

The invention enables the ligament forces to be continuously defined during the operation. For example, when a ligament is subsequently severed in order to correct the position of the upper leg and lower leg with respect to each other, the change in pathway in the joint cleft 18 and the spring constant can be used to continuously obtain force data. The size of the joint cleft 18 can be determined with the aid of the navigation system 10, which constantly monitors the position of the femur 11 and the tibia 12 via the attached reference structures 13 and 14 and marker groups 15 and 16. With the aid of the data obtained from the device 1, the navigation system 10 can calculate the forces and tensions of the ligaments for various angular positions of the joint. The surgeon therefore obtains intra-operative feedback on the ligament, which is very helpful for assisting the ligament balancing procedure and kinematic analysis. Exemplary feedback data are shown, for example, in the screen shots 20 and 22 in FIGS. 5 and 7, in which, once the device 1 has been inserted, the values for the joint cleft 18 are displayed.

The navigation system 10, via a video monitor or the like, also can display the force distribution for the medial and lateral ligament in real time while the surgeon flexes (bends) the leg (e.g., the values for the ligament situation in the various extended positions are recorded in the navigation system 10 and the force distribution is calculated). The defined ligament situation when the leg is extended is important for ascertaining the position of the implant. Moreover, displaying the force and/or tension situation prevailing in the ligaments in real time enables a movement analysis (kinematic analysis) to be performed.

Real time display is possible due to the “communication” between the knee joint (bone and reference structures) of the device 1 (known spring constant) and the navigation system 10. Using the values for the joint cleft 18 when flexed and extended, the stretching force and the pre-set spring constant, the navigation system 10 can continuously calculate and output the force on the ligaments in various flexion positions using equation 1, for example.
F=k·X Equation 1
In equation 1, F denotes the force on the ligaments (N), k denotes the spring constant (N/m), and X denotes the pathway of the compressed spring in the stretcher mechanism (i.e., the displacement of the end of the spring from its equilibrium position in meters).

In the flexed state, the balancing device 1 will again be present in the joint cleft 18, and the applied stretching force is the same as the stretching force applied in the extended state, since the extended and flexed ligaments are to be equally tensed. The ligament situation when flexed also is stored in the navigation system 10, since the ligament situation when flexed is important for the size of the implant.

A kinematic analysis is performed (e.g., an examination of the tension distribution of the ligaments at different degrees of flexion), wherein the navigation system 10 calculates a possible change in the joint cleft back to a change in the force situation on the ligaments. The surgeon thus is continuously informed whether additional ligaments should be severed for other degrees of flexion.

A kinematic analysis can be performed before or after severing the ligaments, which then provides options for comparison. If, in an optimum ligament situation, the tension differs for different flexion angles, the bone incisions which then follow can be re-planned by the navigation system 10 in order to improve the situation. The combination of ligament balancing, the kinematic analysis and planning the resection ensures that an optimum post-operative ligament situation is achieved, that the femoral and tibial resection planes are optimally planned and, therefore, that the components of the implant are optimally positioned. The “communication” between the balancing aid 1 (hardware) and the navigation system 10 enables a suitable alignment of the leg axis and an optimum post-operative ligament situation.

Once the size of the implant and the incision plane have been calculated (in a 90 degree flexion, the posterior femoral incision point and the proximal tibial incision are parallel), the femoral resection is then performed, optimally adapted to the implant, such that after resection, the flexion cleft and extension cleft are identical in size. Subsequently, the implant is implanted.

Using the invention, it is thus possible to intra-operatively perform the kinematic analysis and balance out the ligaments in a total knee joint replacement operation due to the cooperation between the balancing aid 1 and the navigation system 10. The success of the operation is therefore less dependent on the surgeon's experience, but is rather objectively more predictable due to the data provided by the invention.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. A ligament force detection system, comprising:
a device configured to be inserted between two body structures connected by ligaments, wherein the device exhibits a predetermined elasticity;
a medical navigation system capable of detecting shifts in the body structures, wherein the medical navigation system determines forces acting on the ligaments based on shifts in the body structures and the elasticity of the device.

2. The system as set forth in claim 1, wherein at least one reference device is coupled to each body structure, and the shifts in the body structures are based on shifts of the reference device.

3. The system as set forth in claim 1, wherein the device comprises a spring having a known spring constant.

4. The system as set forth in claim 3, wherein a length of the spring and/or a spring tension can be adjusted by an adjusting mechanism.

5. The system as set forth in claim 3, wherein the device further comprises an outer body in which the spring is mounted, and at least one pair of stretcher extensions that are biased by the spring and can be inserted between the body structures.

6. The system as set forth in claim 5, wherein the stretcher extensions are stretcher plates.

7. The system as set forth in claim 5, wherein the device further comprises two outer bodies, each outer body including a spring and a pair of stretcher extensions arranged adjacent to one another.

8. The system as set forth in claim 7, wherein the two outer bodies are connected to each other at an adjustable distance.

9. The system as set forth in claim 7, wherein the pairs of stretcher extensions extend substantially parallel and substantially in the same direction with respect to one another, and one pair of stretcher extensions has a particular shape to precisely define an anatomical position of a patella during application of the device.

10. The system as set forth in claim 9, wherein the pairs of stretcher extensions are arranged jointed with respect to one another.

11. The system as set forth in claim 1, wherein the navigation system comprises a display, and the navigation system calculates forces acting on the ligaments from the shifts in the body structures and the elasticity of the device, and outputs this information on the display.

12. A method of determining a force applied to a ligament, comprising:
inserting a device between two body structures connected by ligaments, wherein the device exhibits a predetermined elasticity;
detecting shifts in the body structures via a medical navigation system, wherein forces acting on the ligaments are based on shifts in the body structures and the elasticity of the device.
